(19) United States
(12) Patent Application Publication
(10) Pub. No.: US 2014/0229397 A1
(43) Pub. Date: Aug. 14, 2014

(54) SYSTEM AND METHOD FOR MANAGING CHARITABLE DONATIONS

(71) Applicant: Michael Fink, Stevensville, MD (US)

(72) Inventor: Michael Fink, Stevensville, MD (US)

(21) Appl. No.: 14/180,977

(22) Filed: Feb. 14, 2014

Related U.S. Application Data
(60) Provisional application No. 61/764,808, filed on Feb. 14, 2013.

(51) Int. Cl. G06Q 30/02

(52) U.S. Cl. CPC G06Q 30/0279
USPC 705/329

(57) ABSTRACT

A computer-implemented method of facilitating charitable donations using a smart device comprises receiving a transaction amount, assigning the transaction amount into a transaction category, retrieving a donation amount associated with the transaction category, charging the transaction amount plus the donation amount to an account, transferring the transaction amount to complete the transaction, and transferring the donation amount into a donation accumulation account. Based on predefined criteria, a donation is made from the donation accumulation account to a second account which can be a charity account. In some embodiments the donation accumulation account is a virtual account. In some embodiments, a user provides customizable user preferences to the smart device.

### CROSS-REFERENCE TO RELATED APPLICATION

This application claims priority to U.S. Patent Application Ser. No. 61/764,808 filed Feb. 14, 2013, the entirety of which is incorporated by reference herein.

### FIELD

The present disclosure is directed to systems and methods of financial transactions. More specifically, the present disclosure is directed to systems and methods for managing charitable donations by automatically using a donor's preferences to determine a donation amount for designated charities when conducting transactions.

### BACKGROUND

The charitable donation industry is very fragmented and utilizes many ways to collect donations. Traditional charities, such as the American Red Cross, allow individual to make online donations, but their donation technology is very rudimentary. Emerging donation technology has been relegated to text donations usually after a natural disaster, donation websites that focus on grass roots charities and crowd funding platforms, and retail point of sales where specific defined charities are the consumer's only options.

A more focused approach can be found through partnerships with some retail establishments. For example, some groceries stores present the option of adding a charitable donation at checkout by adding a set donation onto the total retail purchase. Such systems do not allow purchasers to selectively choose the charity of their choice or include any customizable preferences, social media integration, or reward programs to promote giving.

Another method of facilitating donations to charity incorporates the use of coin change machines, such as Coinstar, having a donation option incorporated into them. However, the donation process is largely a manual exercise, complicated and not customizable.

People inherently want to help others, and charitable activity can come in many forms. The problem with the current environment is that people need an easier, better and more customizable option to donate with every retail transaction they make or reoccurring service billable they pay and they need a tool to simplify their management of charitable giving.

Research indicates that people have a psychological barrier to giving a dollar (US) or more at retail locations. A ‘round up’ feature may promote more charitable giving by limiting user donations to under a dollar US. It is commonplace to be bombarded with requests for donations, but no system yet exists for actively managing charitable giving by focusing on the user's customizable preferences and functions in an automatic manner which allows predetermined preferences to be applied seamlessly during a transaction.

Specifically, there are currently no donation technologies that allow for automatic depositing of donated funds into an accumulation account, and user customization of the aggregated funds including the ability to manage individual preferences, round-up all or specific retail purchases associated with credit and debit card transactions, create daily ongoing change/coin donations, and advanced integration with social media options, and the ability to store and catalog all annual donations for assistance with end of year tax reconciliation.

### SUMMARY

In some embodiments, a system of facilitating charitable donations comprises a payment instrument, a POS terminal, and a charity. The payment instrument includes an application having stored user customizable preferences for adding a donation amount to specified transactions, and the donation amount is donated to charity according to preset criteria. In some embodiments, the payment instrument and POS terminal are further in communication with a financial institution and/or retailer.

In some embodiments, a system of facilitating charitable donations comprises a payment instrument, a POS terminal, a user interface, a retailer, and a charity. The user interface allows a user to enter user customizable preferences which are associated with the payment instrument. The POS terminal retrieves the user customizable preferences to identify a donation amount associated with the user and applies that donation amount to a transaction. The donation amount is then donated to a charity. In some embodiments, the system is supported by the retailer and/or the retailer is responsible for the donations to charity.

In some embodiments, a system of facilitating charitable donations comprises an application stored on or accessed from a payment instrument. The application includes user customizable preferences comprising at least one transaction category, an assigned charity and donation amount associated with the transaction category, and criteria for making a donation. Transaction data is received at the application from at least one POS terminal or financial account. The donation amount is deposited in an accumulation account external to the application and subsequently donated to charity in accordance with the criteria.

In some embodiments, a system of facilitating charitable donations comprises an application stored on or accessed from a payment instrument. The application includes user customizable preferences comprising at least one transaction category, an assigned charity and donation amount associated with the transaction category, and criteria for making a donation. A virtual donation accumulation account is included on the application. Transaction data is received at the application from at least one POS terminal or financial account. The donation amount is virtually deposited in the virtual donation accumulation account. The application directs a donation be made from a financial account to a charity in accordance with the criteria.

In some embodiments, a system of facilitating charitable donations comprises an application stored on or accessed from a payment instrument which is linked to at least one user account and at least one charity. Transactions conducted by the at least one user account are processed by the application to determine a transaction category and associated donation amount and assigned charity.

In some embodiments, a system of facilitating charitable donations comprises a user interface of an application on a payment instrument which provides a view of the various transaction categories, donation amounts, assigned charities, and criteria for donating to charity.

In some embodiments, a method of facilitating charitable donations comprises receiving, at a computer processor of a payment instrument, a transaction amount; assigning the transaction amount into a transaction category; retrieving a donation amount associated with the transaction category; charging a first account the transaction amount plus the donation amount; transferring the transaction amount to complete the transaction; and transferring the donation amount into a donation accumulation account.

In some embodiments, a method of facilitating charitable donations comprises receiving, at a computer processor of a smart device, transaction data from a point of sale terminal including a transaction amount; assigning the transaction data from the point of sale terminal into a transaction category; identifying a donation amount associated with the transaction data as a function of the user customizable preferences; adding the donation amount to a virtual donation accumulation account; and directing a first account to donate to a charity according to criteria specifying the timing of a donation.

In some embodiments, a method of facilitating charitable donations comprises receiving, at a computer processor of a smart device, transaction data from a point of sale terminal including a transaction amount and information associated one or more accounts;

receiving, at a computer processor of a smart device, user customizable preferences comprising: at least one transaction category; a donation amount for each of the at least one transaction categories; a charity associated with each of the at least one transaction categories; and criteria specifying a timing of a donation; assigning the transaction data from the point of sale terminal into one of the at least one transaction category according to the user customizable preferences; identifying a donation amount associated with the transaction data as a function of the user customizable preferences; providing the point of sale terminal with the identified donation amount to charge the one or more accounts the donation amount in addition to the transaction amount; receiving from the point of sale terminal to a donation accumulation account the identified donation amount; donating from the donation accumulation account to the charity associated with the at least one transaction categories according to the criteria specifying the timing of a donation; and recording the donation in a computer database.

In some embodiments, a method of facilitating charitable donations comprises receiving at a retailer user account information from a POS terminal; identifying a donation amount associated with the transaction data as a function of the user customizable preferences; transferring the donation amount to a POS terminal; depositing the donation amount into an accumulation account; and donating from the accumulation account to a charity based on preset donation criteria. In embodiments, the accumulation account is controlled or administered by the retailer.

In some embodiments, a method of facilitating charitable donations comprises receiving, at a POS terminal, user account information; identifying a donation amount associated with the transaction data as a function of the user customizable preferences; charging the sum of the transaction amount and donation amount to an account or payment instrument; and depositing the donation amount into an accumulation account.

### BRIEF DESCRIPTION OF THE DRAWINGS

FIGS. 1A and 1B are block diagrams of systems of facilitating charitable donations in accordance with some embodiments.

FIGS. 2A and 2B are block diagrams of an architecture of a payment instrument in accordance with some embodiments.

FIG. 3 is an illustration of a user interface of a payment instrument in accordance with some embodiments.

FIG. 4A is a flow chart of one example of a method of facilitating charitable donations in accordance with some embodiments.

FIG. 4B is a flow chart of one example of a method performed by a payment instrument in accordance with some embodiments.

FIG. 5A is a flow chart of one example of a method of facilitating charitable donations in accordance with some embodiments.

FIG. 5B is a flow chart of one example of a method performed by a payment instrument in accordance with some embodiments.

FIG. 6A is a flow chart of one example of a method of facilitating charitable donations in accordance with some embodiments.

FIG. 6B is a flow chart of one example of a method performed by a payment instrument in accordance with some embodiments.

FIG. 7A is a flow chart of one example of a method of facilitating charitable donations in accordance with some embodiments.

FIG. 7B is a flow chart of one example of a method performed by a retailer in accordance with some embodiments.

FIG. 8A is a flow chart of one example of a method of facilitating charitable donations in accordance with some embodiments.

FIG. 8B is a flow chart of one example of a method performed by a point of sale terminal in accordance with some embodiments.

### DETAILED DESCRIPTION

The disclosed systems and methods provide an improved facilitation of charitable giving over conventional methods by enabling a user to enter customizable preferences which are then applied to subsequent transactions to seamlessly donate to charity.

The following description is provided as an enabling teaching of a representative set of examples. Many changes can be made to the embodiments described herein while still obtaining beneficial results. Some of the desired benefits discussed below can be obtained by selecting some of the features or steps discussed herein without utilizing other features or steps. Accordingly, many modifications and adaptations, as well as subsets of the features and steps described herein are possible and can even be desirable in certain circumstances. Thus, the following description is provided as illustrative and is not limiting.

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that a system or apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. The term “adjacent” as used herein to describe the relationship between structures/components includes both direct contact between the respective structures/components referenced and the presence of other intervening structures/components between respective structures/components.

As used herein, use of a singular article such as “a, “an” and “the” is not intended to exclude pluralities of the article's object unless the context clearly and unambiguously dictates otherwise.

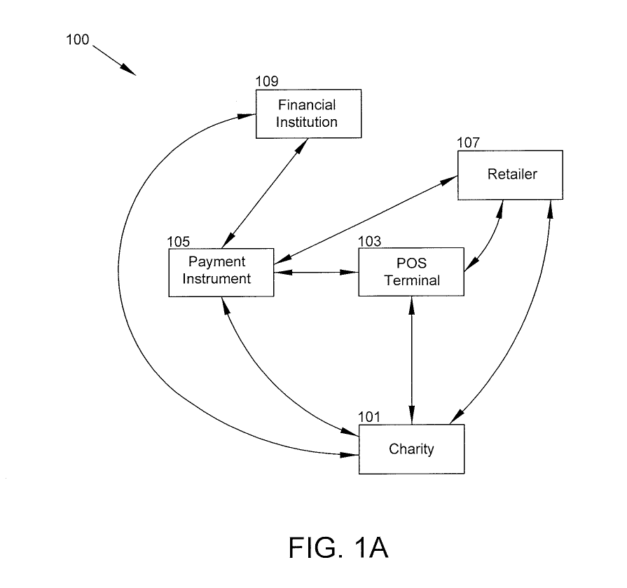

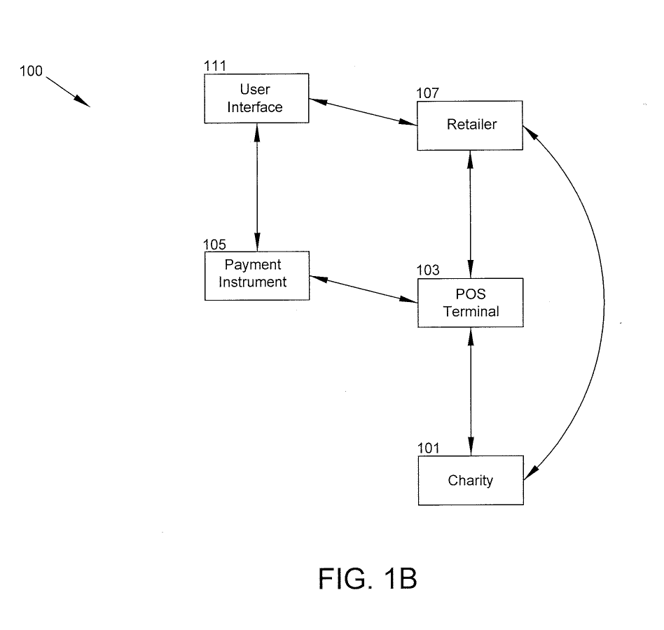

FIG. 1A is a block diagram of a system 100 of facilitating charitable donations in accordance with some embodiments of the present discourse. A charity 101 is operably connected to a point of sale terminal 103, payment instrument 105, retailer 107, and financial institution 109. As used herein, operably connected indicates that the described elements are in at least one-way communication with each other. In some embodiments, this communication is direct wireless communication (radio frequency, infrared, optical) between elements. In various embodiments, this communication is achieved through a cloud based network or the internet. In some embodiments, this communication occurs due to contact between various elements such as swiping a payment instrument 105 through a POS terminal 103.

A point of sale (POS) terminal 103 is operably connect with a charity 101, payment instrument 105, and a retailer 107. A payment instrument 105 is operably connected to a charity 101, POS terminal 103, retailer 107 and financial institution 109. A retailer 107 is operably connected to a charity 101, point of sale terminal 103, and payment instrument 105. A financial institution 109 is operably connected with a charity 101 and a payment instrument 105.

In some embodiments, the charity 101 is a charitable organization or other non-profit. In other embodiments, a charity 101 is a crowd-funding source, retirement savings account, college savings account, or any organizational or individual financial account as defined by the user to include for profit ventures.

In some embodiments the POS terminal 103 is a POS terminal located at a retail store. In other embodiments the POS terminal 103 is an online POS service offered by an e-commerce merchant, or a mobile payment system.

In some embodiments the payment instrument 105 is a smart device such as a smart phone, PDA, tablet, phablet, wearable computer or wearable computer processor-based system, other wearable technology, or other computer-processor equipped mobile device. In other embodiments a payment instrument is a desktop or laptop computer.

In some embodiments, the retailer 107 is a retail store or online merchant. In some embodiments the financial institution 109 includes at least one bank account such as a savings, checking, certificate of deposit, credit card, debit card, or other retail financial account.

FIG. 1B is a block diagram of a system 100 of facilitating charitable donations in accordance with some embodiments of the present disclosure. A charity 101 is operably connected with a POS terminal 103 and a retailer 107. A POS terminal 103 is operably connected with a charity 101, a payment instrument 105, and a retailer 107. A payment instrument 105 is operably connected with a POS terminal 103 and a user interface 111. A retailer 107 is operably connected with a charity 101, POS terminal 103, and user interface 111. A user interface 111 is operably connected with a payment instrument 105 and a retailer 107.

In some embodiments the payment instrument 105 is a smart device such as a smart phone, PDA, other computer-processor equipped mobile device, a smart card, store club card, or a card with a bar code, or any card having the ability to identify a cardholder and accounts associated with the card or cardholder. As used herein, a smart card is one embedded with an electronic chip capable of storing information. In some embodiments, the payment instrument 105 uses Near Field Communications (NFC), RID, QR Code, or other communication protocol to connect with the POS terminal 103. In some embodiments the user interface 111 includes any device which allows a user to alter parameters associated with a payment instrument 105. For example, where payment instrument 105 is a store club card, user interface 111 can be a computer systems capable of accessing the store's club webpage. In other embodiments, the user interface 111 is provided at the POS terminal 103. In some embodiments, the user interface 111 can be provided by the retailer 107.

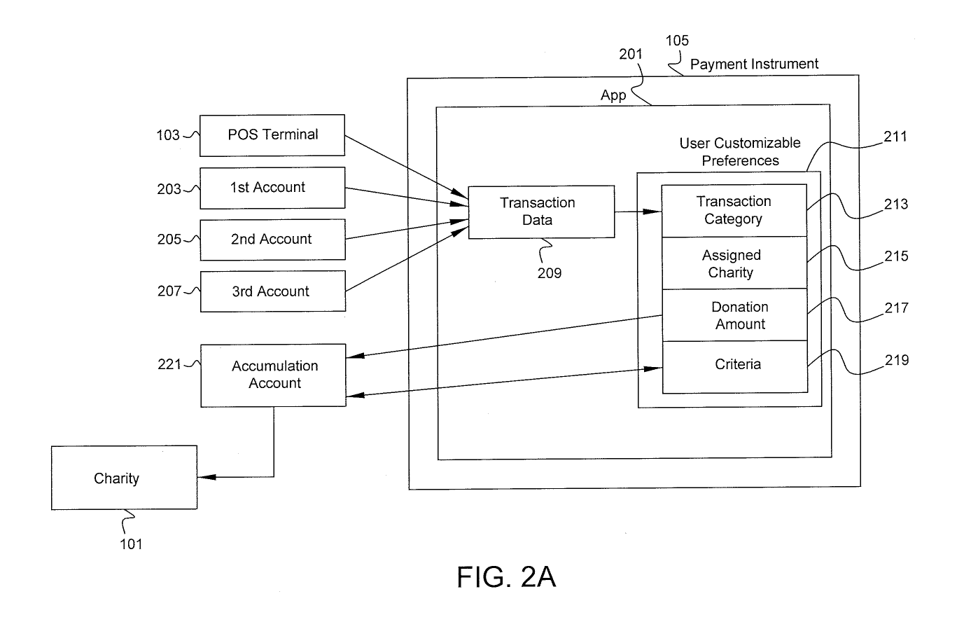

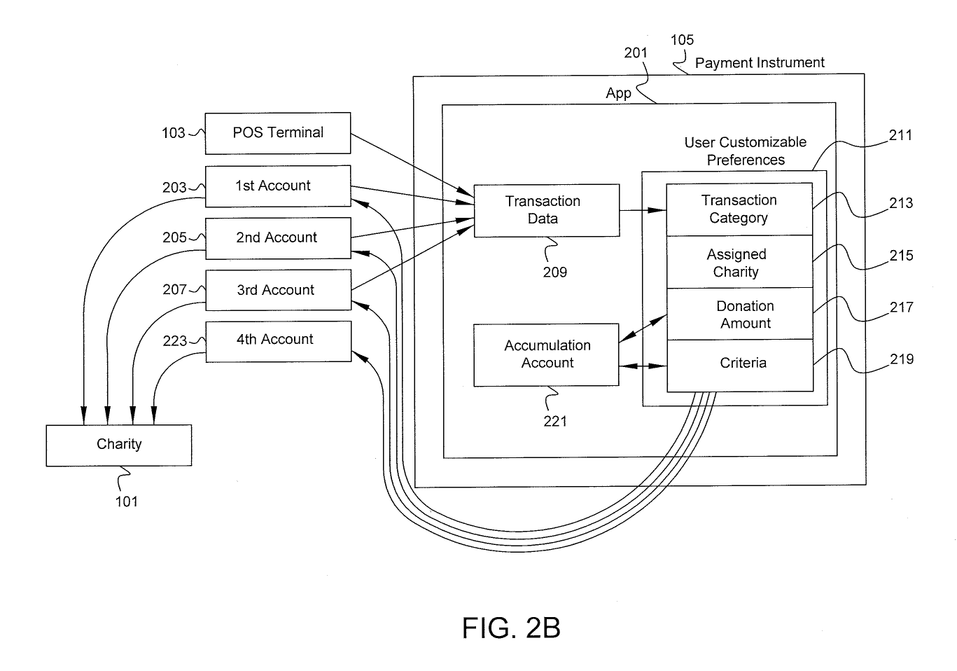

FIG. 2A is a block diagram of an architecture 200 of a payment instrument 105 in accordance with some embodiments. A charity 101 is operably connected to an accumulation account 221. A POS terminal 103 is operably connected to a transaction data 209. An application 201 is stored on or can be accessed by a payment instrument 105. The application 201 is in operable communication with a POS terminal 103, first account 203, second account 205, third account 207, and accumulation account 221. A first account 203, second account 205, and third account 207 provide information to transaction data 209. Transaction data 209 is operably connected to the transaction category 213 of the user customizable preferences 211. User customizable preferences include transaction category 213, assigned charity 215, donation amount 217, and criteria 219. The donation amount 217 and criteria 219 are operably connected to an accumulation account 221.

In some embodiments the application 201 is stored on the payment instrument 105. In other embodiments, the payment instrument 105 accesses the application 201 which is stored on a website or cloud-based network. In still further embodiments an application 201 is run on a payment instrument 105.

In some embodiments the first account 203, second account 205, and third account 207 are credit card, debit card, savings, checking, or other retail financial accounts. In some embodiments, the first, second, and third accounts 203, 205, and 207 are crowd funding sources, accumulation accounts 221 of other users, and any other individual or organizational financial account. Various embodiments allow for the transaction information from first, second, and third accounts 203, 205, and 207 to be uploaded from individual accounts to the transaction data 209.

In some embodiments, the first, second, and third accounts 203, 205, and 207 are provided by a third party account aggregate service, such as Yodlee. Yodlee is an account aggregate service which allows users to view the status of a plurality of their financial accounts (credit, debit, savings, checking, retirement, travel rewards, etc.) in a single user interface. This aggregating service provides a single source of account information from which the present disclosure can facilitate charitable donations. For example, in some embodiments transaction data 209 corresponding to at least one of first, second, and third accounts 203, 205, and 207 is received at payment instrument 105 via Yodlee or a similar account aggregation service.

In some embodiments, transaction data 209 is transferred from first, second, and third accounts 203, 205, and 207 to payment instrument 105 using open financial exchange or OFX. OFX is a unified specification for the electronic exchange of financial data between financial institutions, businesses and consumers via the Internet. In some embodiments, some or all of the transactions, transfers, deposits, and donations described herein are performed using OFX.

In some embodiments, the first, second, and third accounts 203, 205, and 207 are associated with a reoccurring billed account. Example of reoccurring bills can include cable TV, internet service, smart device wireless, and car payment. In other embodiments, the first, second, and third accounts 203, 205, and 207 can be with another users application 201. In some embodiments, the first, second, and third accounts 203, 205, and 207 can be associated with any individual or group account associated with metrics. For example, the account could be linked to a user's Facebook page, Twitter Account, or other social media in which the number of likes, reviewers, or re-tweets measured for a particular account or post can provide input to the transaction data 209 and facilitate a charitable donation according to the user customizable preferences 211. In other embodiments, biometric accounts, such as Nike Plus, FitBit, or other biometric and health accounts can be monitored by the application 201. For example, the number of miles run in a Nike Plus account, or steps taken as listed on a FitBit account can provide the transaction data 209 to facilitate a charitable donation according to the user customizable preferences.

Transaction data 209 can include any data collected by a POS terminal 103 during the performance of a transaction. In some embodiments, transaction data 209 includes a transaction amount, a transaction location, and the parties involved in the transaction. In some embodiments, a transaction location is a retail store, while in other embodiments a transaction location is an online store, mobile device, or other network- or web-based service.

In some embodiments, the user customizable preferences 211 are a set of one or more preferences facilitating charitable donations. Various embodiments can include user customizable preferences 211 for a transaction category 213, assigned charity 215, donation amount 217, and criteria 219. In some embodiments the user customizable preferences 211 can include the account from which a donation is to be made, regardless of the account information supplied by the POS terminal 103, or the first, second, and third accounts 203, 205, and 207.

In some embodiments the transaction category 213 can include one or more types of purchases, purchase location, or the account used in the transaction. For example, types of purchases can include, but is not limited to, restaurants, gas purchases, groceries, and travel-related expenses. In some embodiments the purchase location can include specific stores such as Whole Foods and Target, or specific merchant types such as a grocer, discount warehouse club, and high end clothier. Examples of the account used in the transaction can be credit cards, debit cards, gift cards, cash purchases, and use of virtual currency such Bitcoin.

In some embodiments, the transaction category 213 can include one or more types of items purchased in a given transaction. In such embodiments, transaction data 209 provided by a POS terminal 103 can include an itemized list of purchases which are separated into the plurality of transaction categories 213. For example, where a payment instrument 105 is used at a restaurant, the user customizable preferences 211 allow a user to either designate the entire transaction into the ‘restaurant’ transaction category 213, or to break an itemized list of the transaction into more specific transaction categories 213. Thus a user can assign a donation amount 217 for all restaurant transactions to a first charity, or can assign a donation amount 217 for all food purchased at a restaurant to a first charity but a donation amount 217 for all alcohol purchased at a restaurant to a second charity.

In some embodiments the assigned charity 215 is selected by the user from a list of presented charities or non-profit organizations. In some embodiments the assigned charity 215 can be of the same type as for charity 101. In other embodiments, the user can enter specific organizational and individual accounts to which the donation amount 217 will be transferred.

In some embodiments the donation amount 217 is a formula for calculating a to be transferred amount. Various embodiments will use a formula allowing a user to ‘round-up’ their purchases to the next whole dollar amount. In some embodiments, any foreign and virtual currency can used. Thus, in some embodiments the donation amount 217 is the difference between the transaction amount and the next highest whole dollar amount. In some embodiments the donation amount 217 is a fixed amount for each transaction, such as a fixed dollar amount or a fixed percentage of the transaction total. In some embodiments the donation amount 217 is a user definable portion of the transaction such as a gratuity.

In some embodiments the criteria 219 specifying the timing of a donation monitors the accumulation account balance and directs the accumulation account to 221 make a donation when a threshold or predetermined balance amount is met. For example, the threshold hold could be $1, $50, or any other amount as defined by the user. In other embodiments, the criteria 219 may specify that a donation is to occur on a periodic basis, immediately, manually, or as triggered by some other event. For example, a user may set criteria 219 for periodic donation on a monthly or quarterly basis. As another example, a user may define a donation to be made when ‘likes’ on a charitable organization Facebook reaches a predetermined amount.

In some embodiments the accumulation account 221 is a checking, savings, or money market account at a retail financial institution. In other embodiments accumulation account 221 includes any liquid individual, retail, or institutional financial account. In some embodiments, the accumulation account 221 is a plurality of charity-specific accounts. In still further embodiments, accumulation account 221 is a virtual account which tracks deposited donation amounts 217 without transferring money into the account. In such embodiments, a donation is made based on criteria 219, at which time money is transferred from a separate account (i.e. not the accumulation account 221) to a charity. A virtual donation accumulation account thus reduces transaction volume and transaction costs while maintaining a ledger of donation amounts 217 for later evaluation under the donation criteria 219. In some embodiments a virtual donation accumulation account comprises at least one subaccount, each subaccount associated with a transaction category 213 and an assigned charity 215.

In some embodiments the application 201 includes integration with a user's social media accounts. For example, the application 201 can be set to post to a user's Facebook page, or tweet on a Twitter account, when a charitable donation has been made. Such posting can be performed automatically by application 201 or require manual approval from a user. In some embodiments, a user is prompted to approve a post prior to posting to social media. Social media posting allows promotion of charitable giving, and allows others to like or retweet the charitable giving of others. In some embodiments, postings to social media accounts can occur when certain milestones are met, achievement levels are reached, or a certain event occurs.

FIG. 2B is a block diagram of an architecture 200 of a payment instrument 105 in accordance with some embodiments. The architecture 200 illustrated in FIG. 2B is substantially similar to the architecture 200 illustrated in FIG. 2A. However, notable differences include the addition of a fourth account 223 and the use of an accumulation account 221 which is internal to application 201. Thus a charity 101 is operably connected with a first account 203, second account 205, third account 207, and fourth account 223. A first account 203, second account 205, and third account 207 are operably connected with a charity 101 and a criteria 219. A criteria 219 is operably connected with a first account 203, second account 205, third account 207, and a fourth account 223. An accumulation account 221 is operably connected with a donation amount 217 and a criteria 219. A fourth account 223 is operably connection with a charity 101 and a criteria 219.

In some embodiments, the accumulation account 221 is a virtual account which keeps a running tally calculated donation amounts. In some embodiments, the accumulation account 221 is a plurality of charity-specific accounts as defined by the assigned charity 215 user preferences. In some embodiments a criteria 219 monitors the amount in the accumulation account 221. When the criteria 219 is met, a fourth account 223 is directed to transfer a donation from a fourth account 223 to a charity 101. In some embodiments the fourth account 223 can be the first account 203, second account 205, third account 207, or the account associated with the transaction from the POS terminal 103. In other embodiments, the fourth account 223 can be a separate, liquid individual, retail, or institutional account.

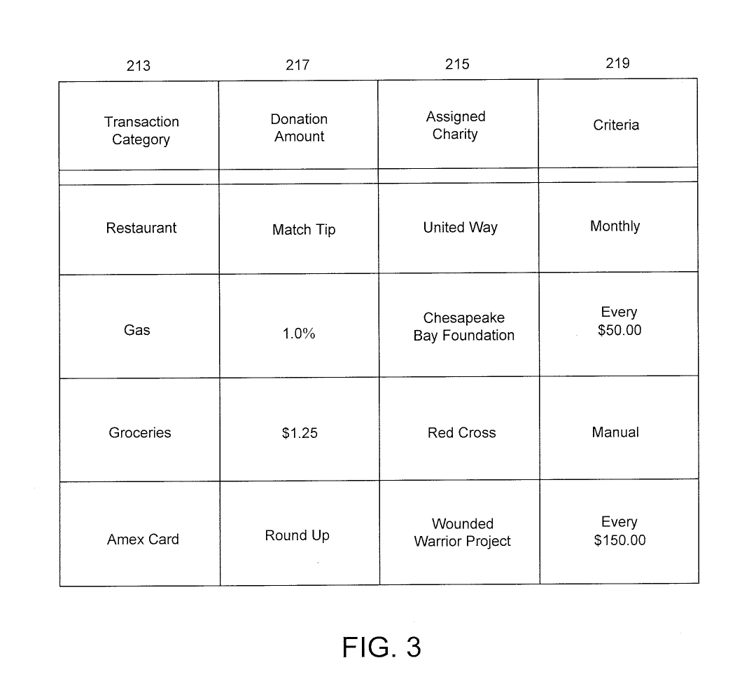

FIG. 3 is an illustration of a user interface 300 of a payment instrument 105 in accordance with some embodiments. User interface 300 is accessible within or through the application 201. In this example, relationship between the transaction category 213, donation amount 217, assigned charity 215, and criteria 219 is shown on the interface 300. A user is able to sort or display the user customizable preferences 211 by transaction category 213, donation amount 217, assigned charity 215, and criteria 219. Further, a user may use the user interface 300 to initially set, alter, or terminate the user customizable preferences 211.

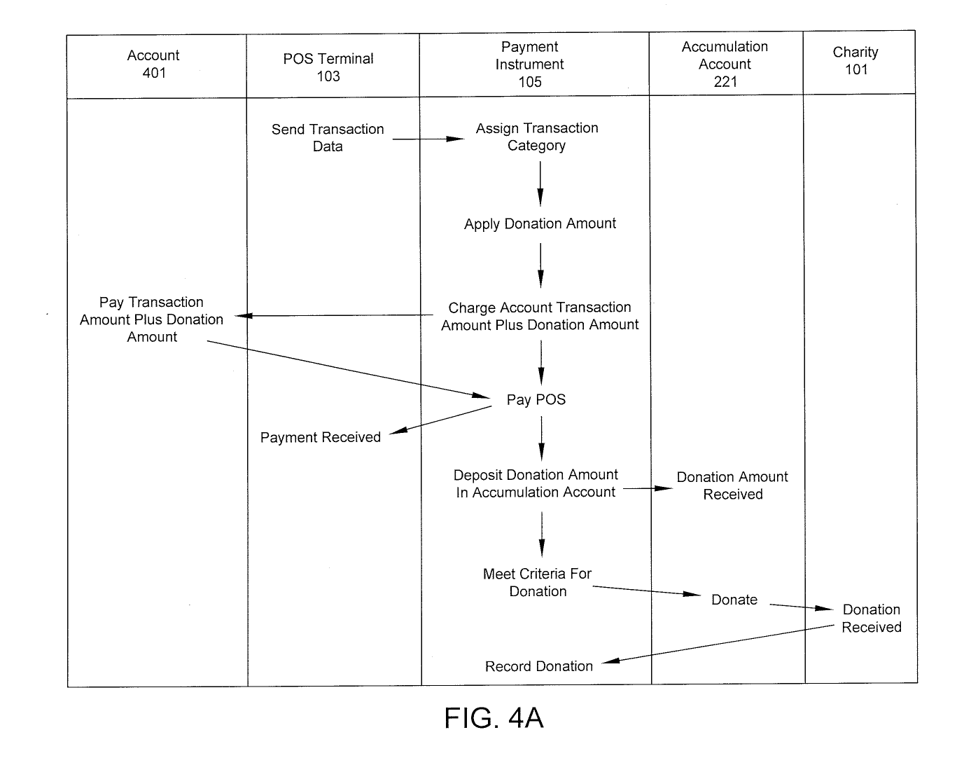

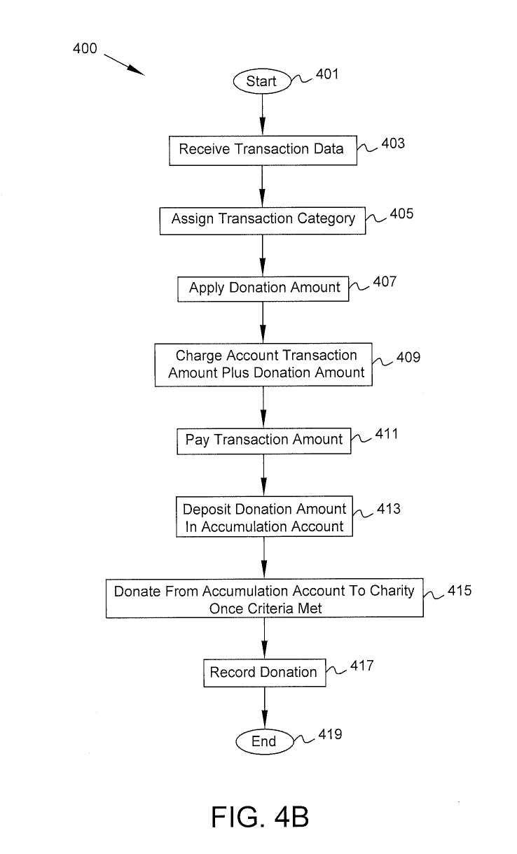

FIGS. 4A and 4B illustrate one example of a computer-implemented method for charitable donations. FIG, 4A is a flow diagram of a charitable donation using the computer implemented method. In some embodiments, the charitable donation begins when a POS terminal 103 sends transaction data resulting from a purchase at a retailer. In some embodiments this data is received at the payment instrument 105. In some embodiments, this data is received as the transaction data 209 at the application 201 stored and processed on the payment instrument 105. In other embodiments, the payment instrument 105 transfers the data to the application 201 in a cloud based network or the internet where it is received as the transaction data 209.

In some embodiments, the application 201 processes the transaction data 209 by assigning it to a transaction category 213. Next, in some embodiments, the application applies the donation amount 217 to the transaction data 209. In some embodiments, the payment instrument 105 charges the account 401 the transaction amount plus the donation amount 217. The account 401 sends information indicating the charge is processed successfully to the payment instrument 105. The payment instrument then directs payment from account 401 to the POS terminal 103 to pay for the transaction amount. The payment instrument 105 also directs a payment of the donation amount 217 to the accumulation account 221. The accumulation account 221 receives this donation deposit.

The application 201 on the payment instrument monitors the accumulation account 221 to determine if the criteria 219 for making a donation is meet. In some embodiments, the application monitors other criteria as specified in the user customizable preferences 211. For example, application 201 can monitor the time and date if the user customizable preferences 201 indicate a periodic or time-based criteria for donating.

When the criteria 219 has been met, the payment instrument 105 directs the accumulation account 221 to donate to the charity 101. The charity 101 receives the donation and sends a confirmation to the payment instrument 105. The payment instrument 105 then records the donation amount in a computer database. In some embodiments the payment instrument 105 can post to social media such as a user's Facebook page, or tweet on a Twitter account, when a charitable donation has been made. This will allow promotion of charitable giving, and allow others persons to like or retweet the charitable giving of the user. In some embodiments, postings to social media accounts can occur when certain milestones are met, achievement levels are reached, or a charitable giving activity occurs.

FIG. 4B illustrates a method 400 performed by a payment instrument 105 during a computer-implemented facilitated charitable donation. At block 401 the method begins with a connection with a POS terminal 103. In some embodiments, the connection made at block 401 is with a first account 203 or a financial data aggregating service. In some embodiments, the financial aggregating service is Yodlee. At block 403 the payment instrument 105 receives transaction data 209 from the POS Terminal 103. The payment instrument 105 processes this transaction data by assigning it to a transaction category 213 at block 407. In some embodiments, the transaction data 209 may represent a plurality of transactions, and the payment instrument 105 may process this plurality of transactions into a plurality of transaction categories 213. At block 409, the payment instrument charges the account 401 the transaction amount plus the donation amount 217. The payment instrument 105, at block 411 pays the transaction amount. At block 413, the payment instrument deposits the donation amount 217 in an accumulation account 413. The payment instrument 105 monitors for the donation criteria 219 to be met. At block 415, the payment instrument 105 donations from the accumulation account 221 once the criteria 219 has been met. The payment instrument 105 then makes record of the donation in a computer database at block 417. Method 400 ends at block 419.

In some embodiments, the payment instrument 105 can connect with a user's social media accounts. When the record of the donation is made to a computer database at block 417, the payment instrument 105 and application 201 can automatically make a record of this donation, or when a user's total donations hits a milestone, by posting to a user's Facebook page, tweeting to the user's Twitter account, or post to some other social media account. In some embodiments, the user will be prompted by the payment instrument 105 or the application 201 to accept or deny the update for one or all of the user's social media accounts. In other embodiments, the user can manually post to the user's social media accounts through the application 201 on or accessed by the payment instrument 105.

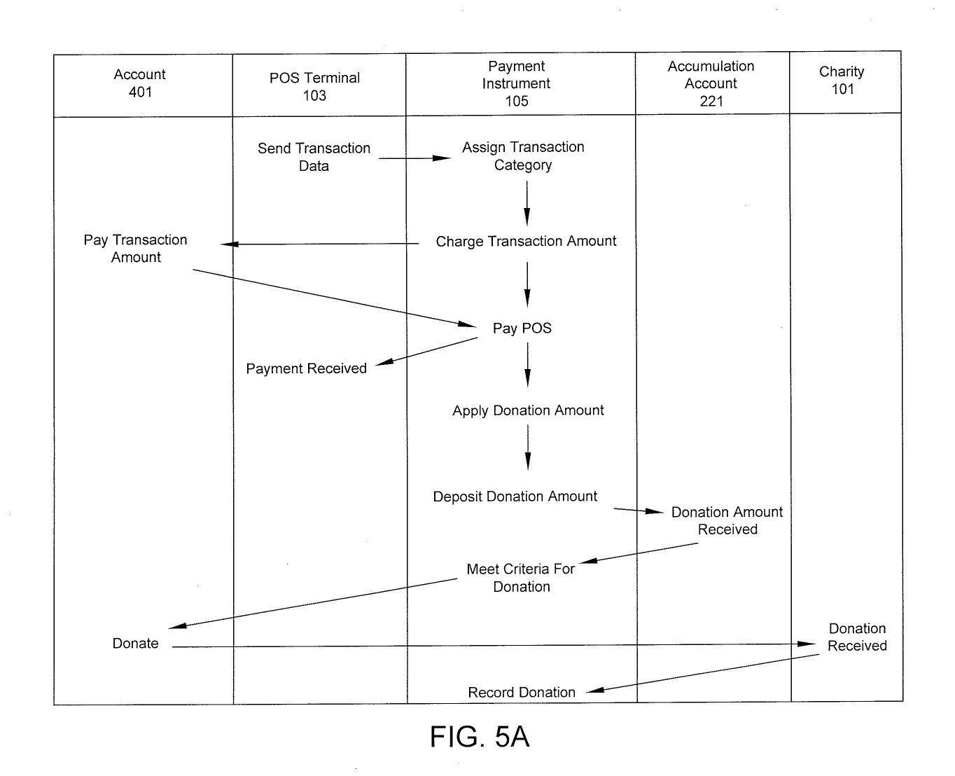

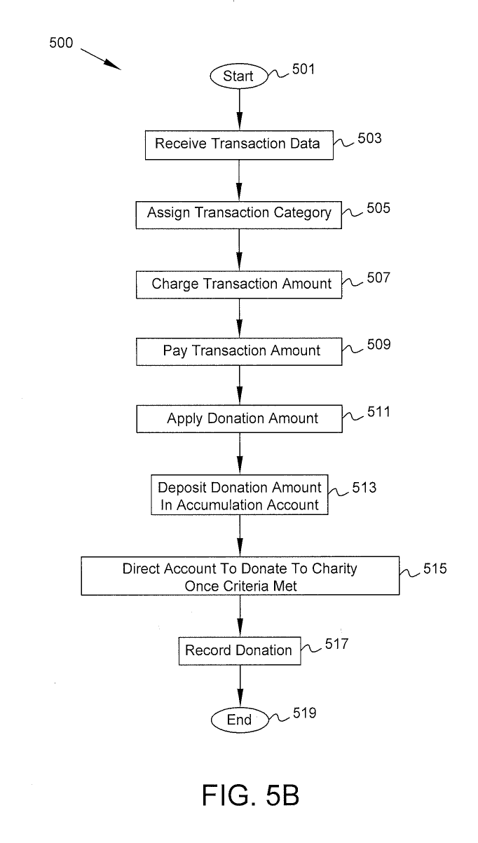

FIGS. 5A and 5B illustrate another example of a computer-implemented method for charitable donations. In the example illustrated in FIGS. 5A and 5B, a payment instrument 105 uses a virtual accumulation account 221 to track donation amounts 217 and directs an account 401 to make a donation once criteria 219 are met.

FIG. 5A is a flow chart of one example of a method of facilitating charitable donations in accordance with some embodiments. In the illustrated example, a POS terminal 103 sends transaction data to a payment instrument 105. Payment instrument 105 assigns the transaction data to a transaction category 213 and then charges account 401 the transaction amount. Upon receipt of the payment from account 401, payment instrument 105 then pays the POS terminal 103 and determines the donation amount. The donation amount 217 is virtually deposited in accumulation account 221. In other words, a record is made in the virtual accumulation account 221 that a credit is to be applied to a predetermined charity. When criteria 219 are met, payment instrument 105 directs account 401 to make a donation to charity 101. In some embodiments, payment instrument 105 directs a separate account distinct from account 401 to make the donation. Payment instrument 105 then records the donation. In some embodiments the payment instrument 105 can post to social media such as a user's Facebook page, or tweet on a Twitter account, when a charitable donation has been made. This will allow promotion of charitable giving, and allow others persons to like or retweet the charitable giving of the user. In some embodiments, postings to social media accounts can occur when certain milestones are met, achievement levels are reached, or a charitable giving activity occurs.

FIG. 5B is a flow chart of one example of a method 500 performed by a payment instrument 105 in accordance with some embodiments. The method 500 begins at block 501. At block 503 the payment instrument 105 receives transaction data 213. In some embodiments, transaction data is received from a POS terminal 103. At block 505, payment instrument assigns the received transaction data 213 to a transaction category 215. At block 507, the transaction amount is charged to an account. At block 509 the transaction amount is paid, and an associated donation amount is determined and applied at block 511. The donation amount 217 is virtually deposited in a virtual accumulation account 221 at block 513. Once criteria 219 are met at block 515, payment instrument 105 directs an account to donate to charity 101. In some embodiments the account utilized in block 515 is account 401. At block 517 the donation is recorded by payment instrument and the method 500 ends at block 519.

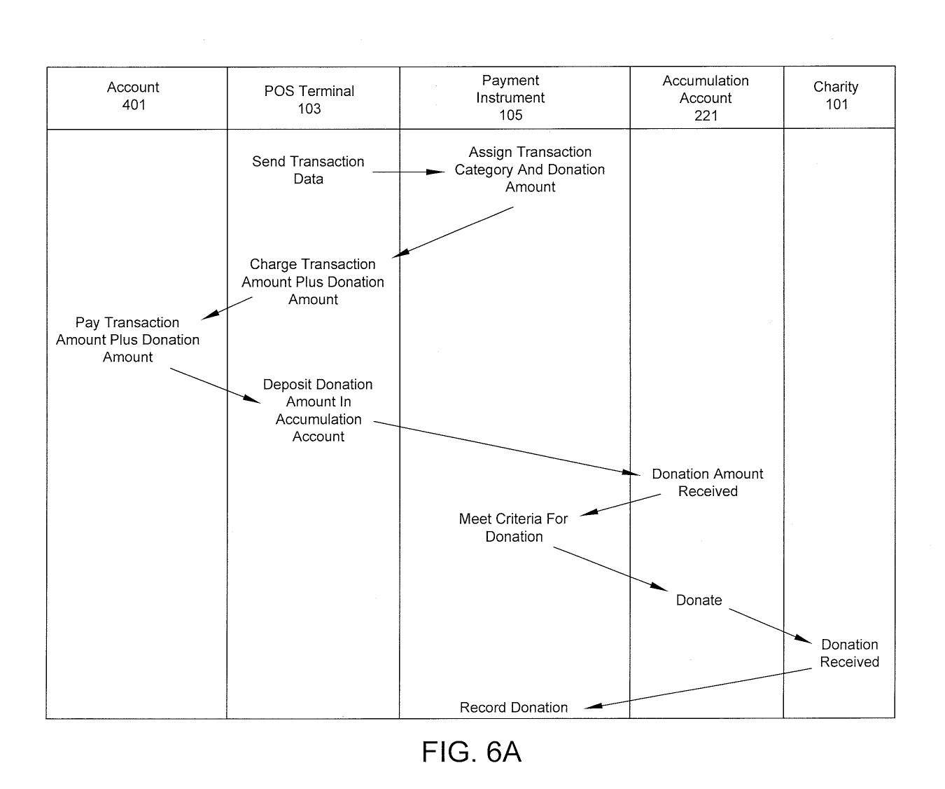

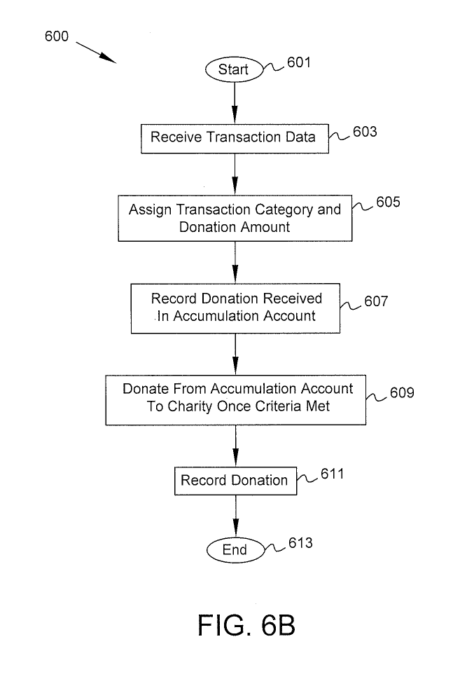

FIGS. 6A and 6B illustrate another example of a computer-implemented method for charitable donations. In the example illustrated in FIGS. 6A and 6B, a POS terminal 103 deposits a donation amount 217 directly to accumulation account 221.

FIG. 6A is a flow chart of one example of a method of facilitating charitable donations in accordance with some embodiments. In the illustrated example, a POS terminal 103 sends transaction data to a payment instrument 105. Payment instrument 105 assigns the transaction data to a transaction category 213 and determines the donation amount 217. Payment instrument 105 then directs the POS terminal 103 to charge the sum of the transaction amount and donation amount. POS terminal 103 charges account 401 the sum of the transaction amount and donation amount, accepting the transaction amount to complete the transaction and depositing the donation amount 217 directly to an accumulation account 221. Payment instrument 105 monitors pre-set parameters such as the account balance of the accumulation account 221 and directs the accumulation account 221 to donate to a charity 101 once criteria 219 are met. Payment instrument then records the donation. In some embodiments the payment instrument 105 can post to social media such as a user's Facebook page, or tweet on a Twitter account, when a charitable donation has been made. This will allow promotion of charitable giving, and allow others persons to like or retweet the charitable giving of the user. In some embodiments, postings to social media accounts can occur when certain milestones are met, achievement levels are reached, or a charitable giving activity occurs.

FIG. 6B is a flow chart of one example of a method 600 performed by a payment instrument 105 in accordance with some embodiments. The method 600 starts at block 601. At block 603 the payment instrument 105 receives transaction data 213. In some embodiments, transaction data 209 is received from a POS terminal 103. At block 605, the payment instrument 105 assigns the transaction data 209 to a transaction category 213 and determines an associated donation amount 217 based on user customizable preferences 211. At block 607 the payment instrument 105 monitors accumulation account 221 and records donation amount 217 once deposited into accumulation account 221. At block 609, payment instrument 105 directs accumulation account 221 to donate to a charity 101 once criteria 219 are met. The donation is recorded by payment instrument at block 611 and the method 600 ends at block 613.

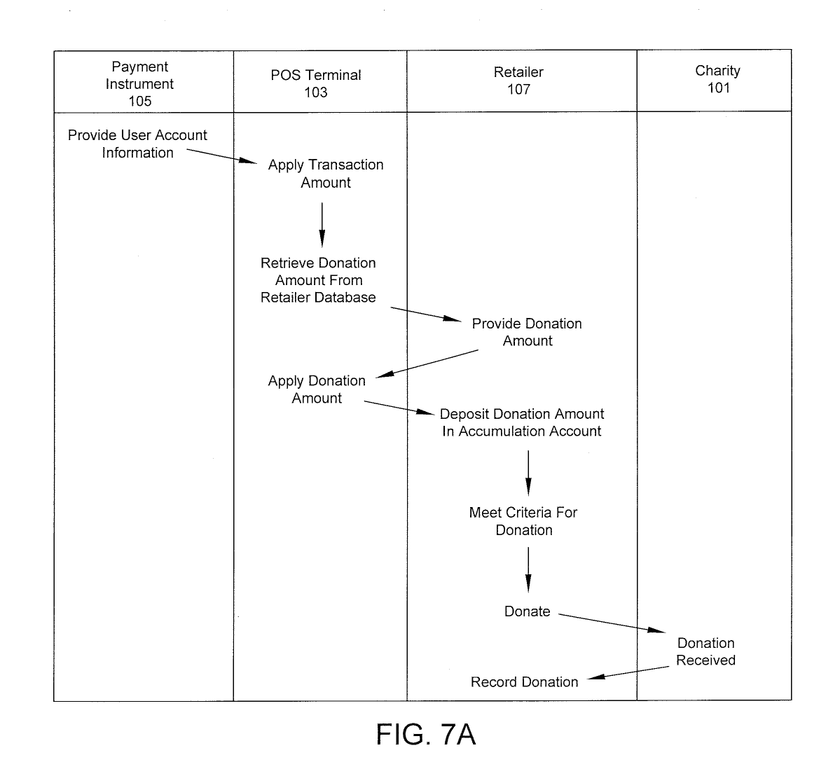

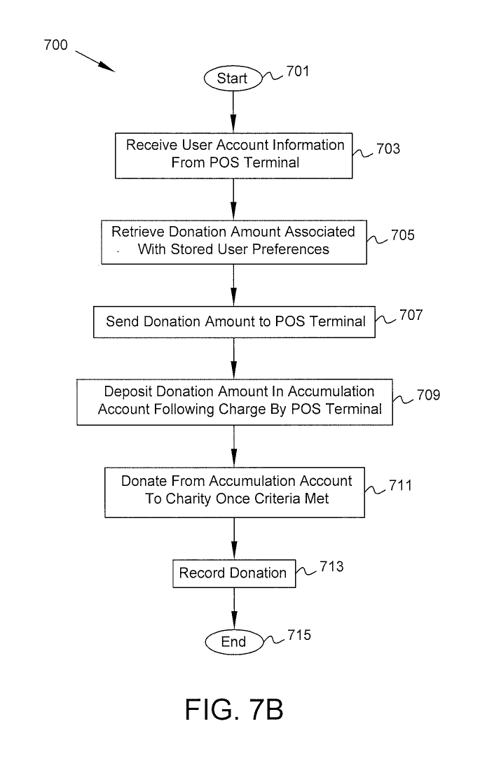

FIGS. 7A and 7B illustrate another example of a computer-implemented method for charitable donations. In the illustrated example, a retailer 107 is responsible for controlling the donation process in place of payment instrument 105.

FIG. 7A is a flow chart of one example of a method of facilitating charitable donations in accordance with some embodiments. The example begins with a payment instrument 105 providing user account information to a POS terminal 103. In some embodiments, user account information is a user account number. In other embodiments, user account information includes a name associated with the user account and user customizable preferences 211. The POS terminal 103 applies a transaction amount and retrieves a donation amount 217 based on the transaction amount from a database maintained by retailer 107 which includes the user customizable preferences 211 associated with the provided user account information. Retailer 107 provides the donation amount 217 to POS terminal 103, which then charges the sum of the transaction amount and donation amount 217. POS terminal 103 sends the donation amount 217 to retailer 107, which then deposits the donation amount 217 into an accumulation account 221 maintained by retailer 107. Retailer 107 monitors criteria 219 based on the user customizable preferences 211 and, once met, donates from the accumulation account 221 to a charity 101. The retailer 107 then records the donation. In some embodiments the retailer 107 can post to social media such as a user's Facebook page, or tweet on a Twitter account, when a charitable donation has been made. This will allow promotion of charitable giving, and allow others persons to like or retweet the charitable giving of the user. In some embodiments, postings to social media accounts can occur when certain milestones are met, achievement levels are reached, or a charitable giving activity occurs.

FIG. 7B is a flow chart of one example of a method 700 performed by a retailer 107 in accordance with some embodiments. The method 700 begins at block 701. At block 703 the retailer 107 receives user account information from POS terminal 103. Retailer 107 then retrieves a donation amount 217 associated with stored user customizable preferences 211 for the user account at block 705. In some embodiments, user customizable preferences 211 are stored in a database maintained by retailer 107. At block 707 the retailer 107 sends donation amount 217 to POS terminal 103. At block 709, the donation amount 217 is deposited by retailer 107 in accumulation account 221 following a charge by POS terminal 103. At block 711, once criteria 219 are met a donation is made from accumulation account 221 to charity 101. The donation is recorded at block 713 and the method 700 ends at block 715.

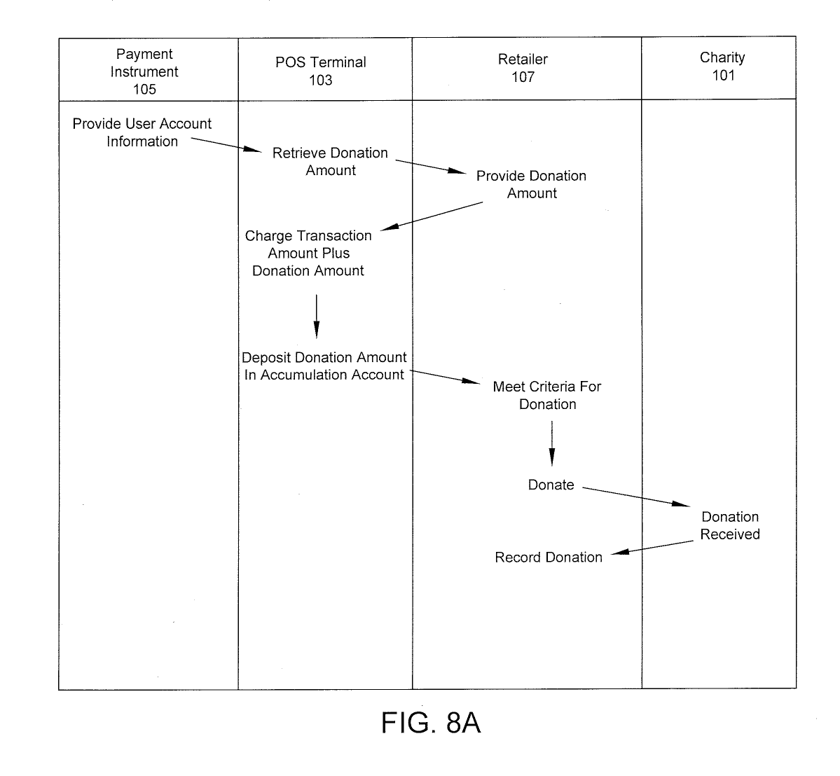

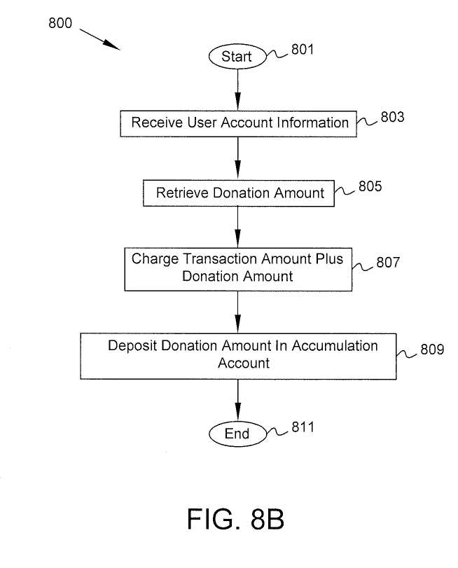

FIGS. 8A and 8B illustrate another example of a computer-implemented method for charitable donations. In the illustrated example, a POS terminal 103 retrieves a donation amount 217 from retailer 107 and deposits the donation amount 217 directly into accumulation account 221.

FIG. 8A is a flow chart of one example of a method of facilitating charitable donations in accordance with some embodiments. The example begins with a payment instrument 105 providing user account information to a POS terminal 103. In some embodiments, user account information is a user account number. In other embodiments, user account information includes a name associated with the user account and user customizable preferences 211. The POS terminal 103 retrieves a donation amount 217 from a database maintained by retailer 107 which includes the user customizable preferences 211 associated with the provided user account information. Retailer 107 provides the donation amount 217 to POS terminal 103, which then charges the sum of the transaction amount and donation amount 217. POS terminal 103 deposits the donation amount 217 directly in an accumulation account 221. Retailer 107 monitors criteria 219 based on the user customizable preferences 211 and, once met, donates from the accumulation account 221 to a charity 101. The retailer 107 then records the donation. In some embodiments the retailer 107 can post to social media such as a user's Facebook page, or tweet on a Twitter account, when a charitable donation has been made. This will allow promotion of charitable giving, and allow others persons to like or retweet the charitable giving of the user. In some embodiments, postings to social media accounts can occur when certain milestones are met, achievement levels are reached, or a charitable giving activity occurs.

FIG. 8B is a flow chart of one example of a method performed by a point of sale terminal in accordance with some embodiments. The method 800 begins at block 801. At block 803 the POS terminal 103 receives user account information and at block 805 POS terminal 103 retrieves a donation amount 217. In some embodiments, the donation amount 217 is retrieved from a database maintained by retailer 107. At block 807 the POS terminal 103 charges an account the sum of the transaction amount and donation amount 217. At block 809, POS terminal 103 deposits the donation amount 217 directly to an accumulation account 221. The method 800 ends at block 811.

In one embodiment, the present disclosure is implemented in a mobile and web platform that will revolutionize charitable donations and giving based on all retail credit and debit card transaction activity for users. The actual denomination amounts of each contribution can be based on rounding up to the next highest dollar amount the “change/cents” of each transaction, or can be a set amount selected by the user. An aggregated account can be linked to a plurality of credit, debit, checking or other accounts and users can customize preferences in each account which controls how money is deposited or transferred into the aggregated account. For example, the user preferences may include association of certain credit or debit cards to different donation causes, selection of specific charitable items within the causes (targeted donations), selection of merchant types of retail transactions to attach to donations, selection of reoccurring service billables to attach to donations, and monthly and annual achievement levels for multiple causes they select, crowd funding teams and causes, social media promotion (as an example Facebook, Twitter, Instagram, Linked In, etc.) of activity and achievement levels, text and email alerts associated with account activity, achievement levels, reward program offers, tax preparation reports, personalize charity and corporate partner communication, and team funding activity.

In some embodiments a user has the ability to personalize and customize charitable giving by donating each time a user makes any purchase with their credit or debit cards or cash or reoccurring service billing or other account and to promote the ongoing giving and achievement level (user defined target levels) through social media networks and team funding participants. The simplicity involved in setting up the account preferences and associating them with a user's account and defined credit and debit cards facilitates the efficiency of the technology by utilizing a “set it and forget it” methodology while also promoting charitable giving with every purchase they make. Another important aspect is having a centralized location for users to store and manage all of their annual giving, both inside and outside of the use of the present disclosure, for tax preparation purposes.

In one embodiment, a user may attach multiple credit, debit cards and other service billing accounts to an aggregated account for “round up” donations associated with specified transaction categories of retail transactions. For example, a user may designate that a specific credit card as a transaction category 213 to rounds up transactions for purchases at restaurants only and transfers the amount to the aggregated accumulation account, and may designate that a specific debit card rounds up transactions for purchasing airline tickets only and transfers the amount to the aggregated accumulation account. The transfers may be done in real time at the time of the purchase transaction, or may be accomplished in periodic sweeps, i.e., daily, weekly, monthly, etc. In another embodiment, a user may specify that all credit and debit cards round up all transactions and transfers the amount to the aggregated account.

In another embodiment, the debit and credit cards can identify specific charitable causes related to a given charity to receive the amounts from the round up transactions. The amount collected in the aggregated accumulation account can be transferred to the respective charitable causes associated with the specific cards on a real-time basis or periodically using sweeps according to the criteria 219.

In another embodiment, the credit card or debit card issuer or bank can automatically transfer the designated amount directly to the charity bypassing the aggregated account.

In another embodiment, the aggregated accumulation account activity of the user can be linked to the selected social media accounts associated with the user. The social media accounts can announce the specific activity in the aggregated account or can identify when the user has reached specific achievement levels. Linking the aggregated account to the social media accounts may be used to encourage others to make charitable donations and can result in the user receiving “karma points” or “acts of kindness and reward points” based on user posting to social media and subsequent response to postings. For example, a user may announce when his charitable donations through the aggregated account reach certain achievement levels on his Facebook account. In response, viewers of the Facebook posting may “like” the posting. For each “like” posting, the user may receive a specified amount of karma points or acts of kindness points. The karma points may be redeemable for prizes or other remuneration. In one embodiment, a retailer may enter in agreement with the provider of the aggregated account and issue gift certificates, redeemable at the retailer, to users when their karma points reach a specified threshold. In another embodiment, a social media account can be used to increase the amount of karma points of a user by taking into account the charitable giving of others who have viewed the user's social media account. For example, a user's social media account can announce the charitable giving levels of a user including the charity that received the donations. The social media account can encourage viewers to make their own charitable contributions. In response to a viewer making a charitable contribution, additional karma points can be credited to the user whose social media account encouraged viewers to make additional donations.

In some embodiments, competitive games can be used to compare various users' charitable giving and received karma points. In some embodiments, retail stores, manufacturers, and other organizations can create reward programs for discounts or free merchandise based on a user's charitable giving and karma points. In some embodiments, karma points can be earned by becoming a user of the application 201, setting assigning a charity or modification of any of the user customizable preferences 211, by making charitable donations, posting charitable donations to social media accounts, receiving likes, retweets, or other acknowledgement of charitable giving on a social media account, reaching donation milestones, achievements, and badges, sending donations to another user of the application, clicking on application advertisements, inviting others to become users, or purchases made through affiliated organizations.

In another embodiment a user can also achieve karma points by click-thrus of advertisements within their social media accounts. For example, a user can click an advertisement for Coca Cola and receive a certain number of karma points for clicking thru the Coke ad but also receive special additional points from the retailer if the retailer is a partner or sponsor of the designated charity of the user, for instance if the user's designated charity is Special Olympics who Coke has a partnership.

In some embodiments a user interface 111 can be provided to assist the user in setting up an aggregated accumulation account and customizing the preferences associated with the accumulation account including selecting credit or debit cards, recurring billing accounts, charities, and selecting the user customizable rules for which donations are collected in the aggregated accumulation account and distributed to the appropriate charities or accounts. The user interface 111 allows the selection of the social media accounts to be linked to the aggregate account including, Twitter, LinkedIn, Instagram, Facebook, MySpace, Tumblr and Google plus, etc. The user interface allows the selection of foreign currencies and foreign languages to accommodate the needs of the user. The user interface also allows the identification of the hardware and software to be used by the user including the smart phone, tablet, or other payment instrument 105 normally used, the user, and the preferred wireless technology for implemented to carry out the present disclosure. Information input through the user interface can be used to embed information on a smart card or other intelligent device or payment instrument 105 that can identify the user and the preferences to be used to implement the present disclosure. The user interface may allow the designation of teams or link the aggregated accounts of multiple users. The user interface also allows users to set preferences for automatically sending e-mails, text messages and posts to social media reflecting activity in the aggregated account.

In one embodiment, the aggregated accumulation account can be considered a user's “charitable giving” account and serve as a repository for all charitable giving of the user in and outside of the users application donations. For example, the aggregated accumulation account can be used to catalog individually all donations/contributions made annually as a repository and for year-end tax preparation and tax software integration. Donation activity inside of the user's application account will automatically be stored and cataloged. Any donation activity outside of the user's application account can also be uploaded and stored via photo, email, text, and through manual entry (by way of example, a user can manually enter a church donation made through a mechanism within the application and also take a photo of a Goodwill donation receipt and upload that receipt into the user's account. The donation amount and type will be automatically calculated through a defined metric or enable the user to manually assign the amount and type).

An application program interface (API) defines interactions between software programs. API as used herein references a programming code which allows the disclosed system to interface with retail store POS terminals and clubs programs, online merchants, mobile payment systems, travel reward accounts, gaming programs, and biometrics. In some embodiments, the disclosed system receives transaction data and transfers user customizable preferences using APIs. In some embodiments, the disclosed system communicates with other systems and applications, both internal and external to the payment instrument, using APIs.

In one embodiment, an API will be administered with credit card and affinity card providers to enable real-time transaction and donation calculations. Transaction donations would then appear on the users credit card statements and further delineate and streamline donation data to the user and expand the reach of the application and giving process model.

In one embodiment, the aggregated accumulation account may also be used to catalog and store retail affinity and membership cards and reoccurring donations to each aggregated accumulation account for transactions integration at the specific retail level. The user can scan their aggregated account personalized QR code or barcode or membership card or payment instrument 105 at any retailers POS to make donations to their aggregated accumulation account. In another similar embodiment, an API will be administered with retail membership and affinity platforms and card providers to enable donation collections of non-credit card donations or coin/cash denominations at the point of sales. By way of example, a user can associate their user account information with their Sam's Club membership card and if the user pays for items in cash, Sam's Club can collect the coin/cash donations and provide to users pre-defined charities in their accounts in the application. The user identification code can be accessed through the application 201 to display a barcode, QR code, or other standard format to display at a POS terminal 103. In some embodiments this code can be used to receive and redeem corporate incentives received thru push notification. In some embodiments, this notification will be based on the proximity and geolocation of the user's payment instrument 105.

In one embodiment another API will be administered with any user's service providers that include a re-occurring billing invoice to the users. By way of example, a user can associate their user account information with Verizon for their phone bill or Comcast for their cable television bill).

In one embodiment, the aggregated account can be associated with other aggregated accounts of other account holders to promote and enable crowd funding option. The crowd funding goal and achievement levels can be posted on the social media accounts of the members of the crowd fund and activate a multi-layer karma points function.

The present disclosure can also include functionality to use unique barcodes and QR codes for tracking donations associated with kiosks. For example, coin kiosks for collecting loose change coins are becoming more prevalent in retail establishments.

In one embodiment, a collection kiosk can collect coins or paper money and at the completion of the collection automatically and electronically transmit that collection to the aggregated account for donation in accordance with the user's preferences. The process would involve the users smart phone or other mobile device or the users application membership card. For example, the user may be issued a membership card with the user's specific information imbedded in a barcode or QR code or radio frequency identification (“RFID”) technology or near field communications (“NFC”) technology on the card. The membership card can be read by the kiosk using RFID, NFC, Bluetooth, or similar scanning or reading or wireless technology. Alternately, a user's mobile device may employ an application that can generate QR codes or bar codes or transmit signals that associates the user's mobile device with the user's aggregated account. The coin collection machine may be able to read the QR or bar code or receive the signal transmitted by the mobile device and transfer the amount of the coins deposited to an account identified by the read codes. Bluetooth technology, or RFID, or other wireless technology can also be utilized to permit “bumping” of a mobile device and kiosk to transmit information. Thus, the present disclosure can support mobile payment technology by allowing a user to associate a credit card with a QR code or bar code on the user's mobile application. In addition, a user may utilize their aggregated account membership card that contains their personalized barcode or QR code for use at the kiosk.

In one embodiment, an API can integrate with other crowd funding platforms to integrate and receive content of causes. An example of this would be receiving cause data from a site like Kickstarter or IndieGoGo.

In one embodiment, an API can be developed to integrate with existing and future mobile payment technologies such as Isis, Square, Intuit, and Apria, and can utilize mobile applications to support Apple Passbook and Google Wallet for account replenishment and usage all retailers that support these technologies. APIs and interfaces will be used to interoperate with Apple's “iTunes”, Google's “Google Play” and Android Application store, and Microsoft's “Windows Store”. This will allow users to donate to their aggregated account from their personal accounts from these services.

In some embodiments the API will integrate with POS providers such that the application and payment instrument can operably connect with a POS terminal. In some embodiments, such operable connection is made using wireless technology. In other embodiments, such operable connection can be made using RFID, NFC, or similar communication technology.

In some embodiments, the API can integrate with retailers, banks, or other financial institutions. This would allow charitable donations to be made directly by the financial institutions based on the user customizable preferences. In addition, this would allow donations to show directly on the users financial statements. In other embodiments the API will integrate with POS systems and retailer back end financial systems to integrate customer loyalty and club programs with a user's donation preferences.

Other APIs allow users to utilize their karma points with rewards programs of retail partners. With this functionality, users will have the ability to transfer their karma points to a retail partner where the user has a rewards account (by way of example, a user can transfer rewards to their Safeway rewards account) or redeem their Karma points for corporate retail partner discounts and items. By way of example, a user can redeem karma points for Coke products or discounts based on account analytics tied to Coke or receive a corporate donation match such as a user's defined charities would receive a donation match based on account analytics or similar charity sponsorship by that corporate partner.

In some embodiments a location based notification service can provide a user information regarding organizations support charities to which the user also donates. In one example, the user may support a charity dedicated to saving the rainforest. Location information from the payment instrument 105 is paired with near-by retailers supporting the same cause. A notification such as an email, text, SMS, or application based notification can inform the user of these retailers. In some embodiments, retailer incentives for discounts, donation matching, or promotions for redeeming karma points can be included in the notification.

In another embodiment, the karma points can be integrated with the rewards program provided by the mobile and social media gaming industry. For example, the provider of the aggregated account can have a reciprocal rewards point agreements with gaming applications. By way of another example, when a gaming customer downloads or purchases a gaming application, this application will send notification to provider of the aggregated account to credit this customer a predefined number of karma points.

In one embodiment, the present disclosure can be utilized with its donation and other platforms using numerous biometric scanning capabilities including; fingerprint scanners, finger and palm vein scanners, and iris scanners to associate an individual's identity with a designated charity.

In another embodiment, a gaming platform (mobile and web and hard game board) is provided to enable users to compete and donate funds to their favorite charities and receive karma points like they would in the donation applications. For example, a gaming account like Xbox Live could be a user's first, second, third, or fourth accounts 203,205,207, or 223, providing input data for a donation. In some embodiments, corporate sponsors of games could provide matching donations based on a user's performance in a game and the user's customizable preferences. For example, a game score can be associated with a predetermined donation amount from a corporate partner.

In another embodiment, a data analytics application that will calculate various metrics associated with a user's account to identify a user's personalized donation preferences and retail purchases in order to identify a user's purchase data and analytics and comparative donation preferences which can be made available to charity and corporate retail partners for marketing usage and rewards program options.

In some embodiments corporate and retail partners can provide incentives to changeup users for donation activity and milestones achieved. In some embodiments, a corporation or retailer will match the donations of a user, provide corporate incentives to include offers sent by messaging through the application 201. In some embodiments incentives can be pushed through notifications on users smart device or other payment instrument 105 using a location based geo location technology.

In some embodiments a Karma Love feature is used in the application 201 to connect users to each other and users to non-users by way of sending money to each other through the application for use in the recipient's desired charity or causes. The denomination sent can be any amount and can be used by the recipient immediately or stored for future use in either applying the amount received to someone's changeup donations (rounded up active donations tied to their credit card) or through a donate now (an immediate donation) option. In some embodiments the sender of the karma love receives karma points for their good deed for another's use for a good deed.

In some embodiments the application 201 will promote community giving by creating a game of team donation activity between users. In some embodiments participation in teams will promote giving on a community social network level while fostering friendly competition between teams. In some embodiments, competition can be created between offices/companies in an office building with the winner receiving karma points, milestones, achievements, corporate incentives, or other incentives.

Thus, the present technology 1) provides the ability for users to create round-up change, reoccurring, immediate donations (donate now and karma love) denomination donations that include customized preferences, 2) integrates user preferences with daily donations made with each retail purchase transactions and reoccurring service billings, 3) integrates daily donations with their credit and/or debit cards and cash purchases, 4) integrates their aggregated account with popular social media networks to promote giving and achievement levels, 5) provides a rewards program integrated with a user's donation achievement and application activity and promotions, 6) manages all annual donations, and provides a repository for all donations made within and outside of their aggregated account, and 7) promotes community and universal giving by creating a game of charitable donations using teams and/or competitions and sending user to user and recipient to charity donations (karma love). The end result is the present disclosure combines proprietary technology with available software and technology such as Yodlee and with common online charitable donation practices to create a comprehensive solution to simplify and customize individual charitable giving associated with everyday retail purchases and reoccurring service billings.

The present disclosure can be implemented by a general purpose computer, Smart phone, tablet, phaplet, PDA, and wearable technologies programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, app, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network or as an app on a mobile device such as a tablet, Phablet, PDA, smartphone, or wearable technology.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer or mobile device, smartphone or tablet. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a mobile smartphone, a personal digital assistant (PDA), tablet, a mobile audio or video player, a game console, a Global Positioning System (GPS) receiver, to name just a few.

Computer readable media suitable for storing computer program instructions and data include all forms data memory including non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor or other monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What we claim is:

1. A computer-implemented method of facilitating charitable donations comprising:
receiving, at a computer processor of a smart device, transaction data from a point of sale terminal including a transaction amount and information associated with one or more accounts;
receiving, at a computer processor of a smart device, user customizable preferences comprising:
at least one transaction category;
a donation amount for each of the at least one transaction categories;
a charity associated with each of the at least one transaction categories; and
criteria specifying a timing of a donation;
assigning the transaction data from the point of sale terminal into one of the at least one transaction category according to the user customizable preferences;
identifying a donation amount associated with the transaction data as a function of the user customizable preferences;
providing the point of sale terminal with the identified donation amount to charge the one or more accounts the donation amount in addition to the transaction amount;
receiving from the point of sale terminal to a donation accumulation account the identified donation amount;
donating from the donation accumulation account to the charity associated with the at least one transaction categories according to the criteria specifying the timing of a donation; and
recording the donation in a computer database.

2. The method of claim 1 wherein the donation amount is the difference between the transaction amount and the next highest whole dollar amount.

3. The method of claim 2 wherein the criteria specifying the timing of a donation is a fixed period of time.

4. The method of claim 2 wherein the criteria specifying the timing of a donation is a predetermined account balance in the donation accumulation account.

5. The method of claim 1 wherein the donation amount is at least one of gratuity matching, a fixed dollar amount, or a fixed percentage of the transaction amount.

6. The method of claim 1 further comprising:
automatically posting a donation notice to social media.

7. The method of claim 1 wherein a retailer, via the point of sale terminal, matches the donation amount to be transferred into the donation accumulation account.

8. A computer-implemented method of facilitating charitable donations comprising:
receiving, at a computer processor of a smart device, transaction data from a point of sale terminal including a transaction amount;
assigning the transaction data from the point of sale terminal into a transaction category; identifying a donation amount associated with the transaction data as a function of the user customizable preferences;
adding the donation amount to a virtual donation accumulation account; and
directing a first account to donate to a charity according to criteria specifying the timing of a donation.

9. The method of claim 8 wherein the criteria specifying the timing of a donation is a predetermined account balance of the virtual donation accumulation account.

10. The method of claim 9 further comprising:
receiving, at a computer processor of a smart device, user customizable preferences comprising:
at least one transaction category;
a donation amount for each of the at least one transaction categories; and
a charity associated with each of the at least one transaction categories.

11. The method of claim 10 wherein the virtual donation accumulation account comprises a plurality of subaccounts, each subaccount assigned to a charity associated with each of the at least one transaction categories.

12. The method of claim 11 wherein the donation amount is the difference between the transaction amount and the next highest whole dollar amount

13. The method of claim 11 wherein the donation amount is at least one of gratuity matching, a fixed dollar amount, or a fixed percentage of the transaction amount.

14. The method of claim 8 further comprising:
automatically posting a donation notice to social media.

15. A computer-implemented method of facilitating charitable donations comprising:
receiving, at a computer processor of a payment instrument, a transaction amount;
assigning the transaction amount into a transaction category;
retrieving a donation amount associated with the transaction category;
charging a first account the transaction amount plus the donation amount;
transferring the transaction amount to complete the transaction; and
transferring the donation amount into a donation accumulation account.

16. The method of claim 15 further comprising:
receiving, at a computer processor of a smart device, criteria specifying the timing of a donation; and
donating from the donation accumulation account to a second account associated with the transaction category according to the criteria specifying the timing of a donation.

17. The method of claim 16 wherein the donation amount and criteria specifying the timing of a donation are received from a user prior to receiving the transaction amount.

18. The method of claim 17 wherein the second account is associated with a charitable organization.

19. The method of claim 17 wherein the second account is associated with a non-profit organization.

20. The method of claim wherein the donation amount is at least one of the difference between the transaction amount and the next highest whole dollar amount, gratuity matching, a fixed dollar amount, or a fixed percentage of the transaction amount.
